(19) United States
(12) Patent Application Publication
(10) Pub. No.: US 2015/0284022 A1
(43) Pub. Date: Oct. 8, 2015

(54) STEERING CONTROL DEVICE

(71) Applicant: TOYOTA JIDOSHA KABUSHIKI KAISHA, Toyota-shi, Aichi (JP)

(72) Inventors: Yoshio Kudo, Machida-shi (JP); Yoshiaki Suzuki, Susono-shi (JP); Yoji Kunihiro, Susono-shi (JP); Ikuo Kushiro, Mishima-shi (JP); Takeshi Goto, Toyota-shi (JP)

(73) Assignee: TOYOTA JIDOSHA KABUSHIKI KAISHA, Toyota-shi, Aichi (JP)

(21) Appl. No.: 14/435,183

(22) PCT Filed: Nov. 5, 2012
(86) PCT No.: PCT/JP2012/078655

§ 371 Date: Apr. 13, 2015

(51) Int. Cl. B62D 6/00; B62D 6/06

(52) U.S. Cl. CPC B62D 6/008; B62D 6/06

(57) ABSTRACT

A steering control device includes a vibration suppression control unit configured to suppress transmission of vibration of a steering system including a steering wheel and a turning wheel, which are mechanically connected to each other, to the steering wheel. The vibration suppression control unit is configured to execute, at a time a braking force is generated on the turning wheel, suppression control of braking time vibration associated with braking operation of the turning wheel based on a value in a predetermined frequency band of a brake fluid pressure of the turning wheel.

### FIELD

The present invention relates to a steering control device for a steering device including a steering wheel and a turning wheel mechanically connected to each other.

### BACKGROUND

A steering device including a steering wheel and a turning wheel which are mechanically connected to each other is conventionally known, and in this type of steering device, when vibration is generated in the device or the vibration is transmitted to the device, the vibration of a steering system is transmitted to the steering wheel through a steering shaft. For example, following Patent Literatures 1 to 4 disclose the technology of suppressing such vibration transmitted to the steering wheel in an electric power steering device which performs assist control of steering torque of a driver by assist torque of a motor. The technology of Patent Literature 1 tries to suppress the vibration of the steering system by extracting a specific frequency component from an output signal of a torque sensor (steering torque of the driver) and increasing a compensation component based on a differential value of the steering torque when the frequency component is not smaller than than a predetermined threshold. The technology of Patent Literature 2 detects the vibration of the steering system based on force on right and left front wheels (force in a vertical direction and force in a front-rear direction) detected by a wheel force detecting sensor and rotary torque at the time of high vehicle speed and suppress the transmission of the vibration to the steering wheel by an output of the above-described motor. The technology of Patent Literature 3 detects uncomfortable vibration of the steering system based on a detection signal of an axial force sensor of a tie rod and a filter and suppresses the transmission of the vibration to the steering wheel by the output of the above-described motor based on an output signal of a steering angular speed sensor (rotational angular speed of the steering shaft). The technology of Patent Literature 4 multiplies a control correction amount according to steering acceleration by an acceleration adaptive gain according to vehicle acceleration and controls the output of the above-described motor based on a multiplication value, thereby suppressing the vibration of the steering system at the time of rapid braking during straight travel (vibration generated on the wheel by braking force transmitted to the steering system).

### CITATION LIST

### Patent Literature

Patent Literature 1: Japanese Patent Application Laid-open No. 2009-090953

Patent Literature 2: Japanese Patent Application Laid-open No. 2005-219539

Patent Literature 3: Japanese Patent Application Laid-open No. 2010-036846

Patent Literature 4: Japanese Patent Application Laid-open No. 2007-186064

### SUMMARY

### Technical Problem

Herein, a frequency band of vibration of a steering system associated with braking force is overlapped with the frequency band of the vibration related to road information. However, since steering torque, wheel force of a front wheel and rotary torque, axial force of a tie rod, or steering acceleration is conventionally used for detecting the vibration, vibration, there is a room for improvement in the detection of the vibration related to the braking force and suppression of transmission of the vibration to a steering wheel.

Therefore, an object of the present invention is to improve disadvantages of such conventional example and to provide a steering control device capable of suppressing the transmission of the vibration related to the braking force to the steering wheel with high accuracy.

### Solution to Problem

To achieve the above-described object, the present invention includes a vibration suppression control unit configured to suppress transmission of vibration of a steering system including a steering wheel and a turning wheel, which are mechanically connected to each other, to the steering wheel, and the vibration suppression control unit is configured to execute, at a time a braking force is generated on the turning wheel, suppression control of braking time vibration associated with braking operation of the turning wheel based on a value in a predetermined frequency band of a brake fluid pressure of the turning wheel.

It is preferable that the vibration suppression control unit is configured to execute the suppression control of the braking time vibration at a time the value in the predetermined frequency band of the brake fluid pressure is not smaller than a predetermined value.

Moreover, it is preferable that the vibration suppression control unit is configured to count number of times the value in the predetermined frequency band of the brake fluid pressure becomes the predetermined value or larger and to decrease the predetermined value at a time the number of times becomes a predetermined number of times or larger.

Moreover, it is preferable that the vibration suppression control unit is configured to change a control gain for suppressing the braking time vibration based on the value in the predetermined frequency band of the brake fluid pressure.

Moreover, it is preferable that the vibration suppression control unit is configured to count number of times the value in the predetermined frequency band of the brake fluid pressure becomes a predetermined value or larger and to change the control gain with respect to the value in the predetermined frequency band at a time the number of times becomes a predetermined number of times or larger.

Moreover, it is preferable that the vibration suppression control unit is configured to execute the suppression control of the braking time vibration based on a differential value of the value in the predetermined frequency band of the brake fluid pressure.

Moreover, it is preferable that the vibration suppression control unit is configured to execute the suppression control of the braking time vibration at a time the differential value of the value in the predetermined frequency band of the brake fluid pressure is equal to or larger than a predetermined value.

Moreover, it is preferable that the vibration suppression control unit is configured to count number of times the differential value of the value in the predetermined frequency band of the brake fluid pressure becomes the predetermined value or larger and to make the predetermined value small at a time the number of times becomes a predetermined number of times or larger.

Moreover, it is preferable that the vibration suppression control unit is configured to change a control gain for suppressing the braking time vibration based on the differential value of the value in the predetermined frequency band of the brake fluid pressure.

Moreover, it is preferable that the vibration suppression control unit is configured to count number of times the differential value of the value in the predetermined frequency band of the brake fluid pressure becomes a predetermined value or larger and to change the control gain with respect to the differential value of the value in the predetermined frequency band at a time the number of times becomes a predetermined number of times or larger.

Moreover, it is preferable that the value in the predetermined frequency band of the brake fluid pressure is a value obtained by performing Fourier transform of a detection signal of the brake fluid pressure in the predetermined frequency band.

### Advantageous Effects of Invention

When a braking force is generated on a turning wheel, a steering control device according to the present invention executes suppression control of braking time vibration of a steering system associated with braking operation of the turning wheel based on a value in a predetermined frequency band of a brake fluid pressure of the turning wheel. That is to say, accuracy of determining whether the braking time vibration is generated is improved by the value in the predetermined frequency band of the brake fluid pressure, so that the steering control device may suppress transmission of the braking time vibration to a steering wheel with high accuracy by executing the suppression control when the braking time vibration is generated.

### BRIEF DESCRIPTION OF DRAWINGS

FIG. 1 is a view illustrating an example of a vehicle to which a steering control device according to the present invention is applied.

FIG. 2 is a view illustrating a gain of a detection signal of a brake fluid pressure of a front wheel with respect to a frequency.

FIG. 3 is a flowchart illustrating suppression control of braking time vibration in the steering control device of an embodiment.

FIG. 4 is a view illustrating a relationship between a FFT peak value and a control gain of vibration suppression in the steering control device of the embodiment.

FIG. 5 is a view illustrating a relationship between a FFT peak value and a control gain of vibration suppression in a steering control device of a second variation.

FIG. 6 is a view illustrating a relationship between a FFT peak value and a control gain of vibration suppression in a steering control device of a third variation.

FIG. 7 is a view comparing determination timing by the FFT peak value and determination timing by a differential value of a FFT peak value in a fourth variation.

FIG. 8 is a view illustrating a relationship among a vehicle speed, a rotational primary frequency of the front wheel, an unsprung resonance frequency of the front wheel, and a range in which the braking time vibration might be generated.

### DESCRIPTION OF EMBODIMENTS

An embodiment of a steering control device according to the present invention is hereinafter described in detail with reference to the drawings. Meanwhile, the invention is not limited by the embodiment.

### Embodiment

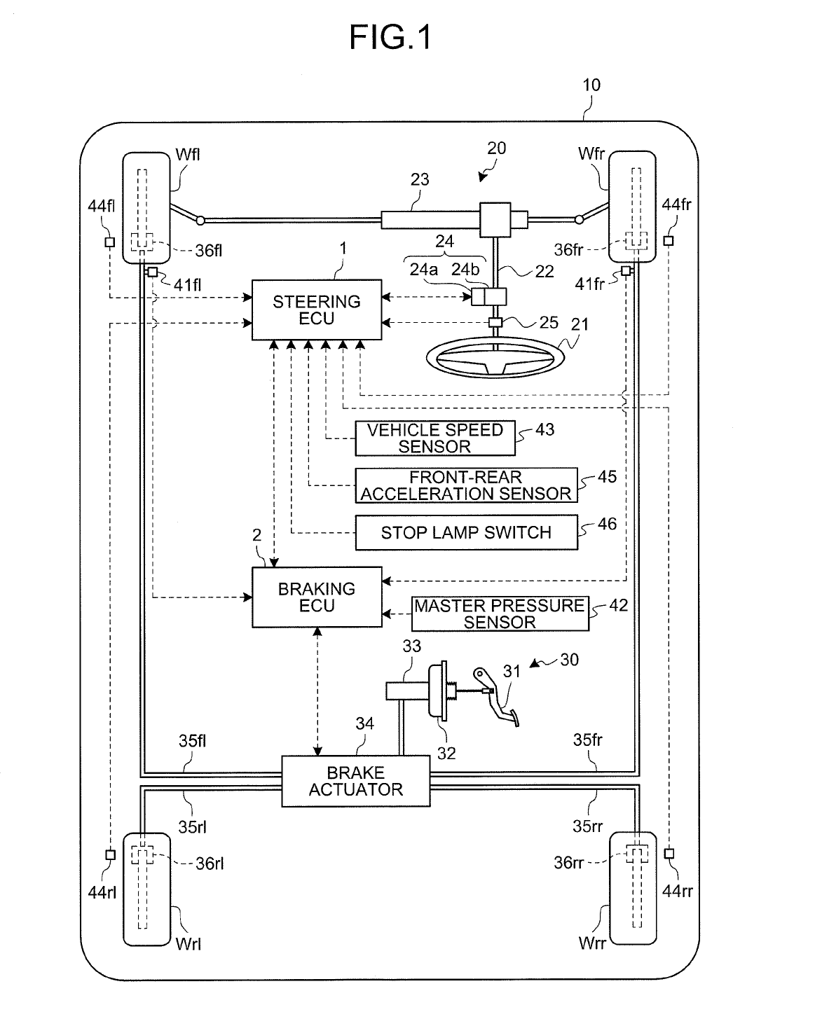

An embodiment of a steering control device according to the present invention is described with reference to FIGS. 1 to 3.

The steering control device of this embodiment performs turning control and the like of a turning wheel (front wheel) Wfi (i=1, r) of a vehicle 10 illustrated in FIG. 1. Arithmetic processing operation of the steering control device is performed by an electronic control unit (hereinafter, referred to as “steering ECU”) 1 mounted on the vehicle 10. A braking control device which performs braking force control of each of wheels Wfi and Wri (i=1, r) of the vehicle 10 illustrated in FIG. 1 is provided on the vehicle 10. Arithmetic processing operation of the braking control device is performed by an electronic control unit (hereinafter, referred to as “braking ECU”) 2. Wfi represents a left front wheel Wfl and a right front wheel Wfr. Wri represents a left rear wheel Wrl and a right rear wheel Wrr.

An example of the vehicle 10 equipped with the steering ECU 1 and the braking ECU 2 is first described. The vehicle 10 is provided with a power source such as an engine (engine such as an internal-combustion engine) and a rotary machine (motor and motor generator) not illustrated and a power transmission device such as a transmission not illustrated which transmits power thereof to a driven wheel. The vehicle 10 is provided with a steering device 20 which turns the front wheel Wfi and a braking device 30 which generates braking force on each of the wheels Wfi and Wri.

The steering device 20 is provided with a steering wheel 21 as a steering operator operated by a driver, a rotary shaft (hereinafter, referred to as “steering shaft”) 22 coupled to the steering wheel 21, and a turning force transmitting unit 23 which turns the front wheel Wfi based on rotation of the steering shaft 22. The steering device 20 is obtained by mechanically connecting the steering wheel 21 to the front wheel Wfi. Therefore, the turning force transmitting unit 23 is provided with a turning force transmitting mechanism which converts rotary torque of the steering shaft 22 to turning force and transmits the same to the front wheel Wfi. The turning force transmitting mechanism is a so-called rack and pinion mechanism formed of a rack gear and a pinion gear not illustrated, for example.

The steering device 20 is configured as an electronic power steering (EPS) device which assists steering operation of the driver. Therefore, the steering device 20 is provided with a steering assisting unit 24 which reduces steering torque of the steering wheel 21 of the driver by assist torque. The steering assisting unit 24 provided with a motor 24a and a decelerator 24b transmits output torque of the motor 24a to the steering shaft 22 through the decelerator 24b. If the transmitted output torque is generated in the same direction as a steering direction of the driver (rotational direction of the steering shaft 22), this acts as the assist torque which reduces the steering torque. The steering ECU 1 calculates a target value of the assist torque based on the steering torque of the driver detected by a torque sensor 25 and the like. The steering ECU 1 controls the motor 24a such that the assist torque reaches the target value. The torque sensor 25 is a resolver sensor and the like, for example, arranged on the steering shaft 22.

The braking device 30 is provided with a brake pedal 31, a brake booster unit (hereinafter, referred to as “brake booster”) 32, a master cylinder 33, a fluid pressure adjusting unit (hereinafter, referred to as “brake actuator”) 34, brake fluid pressure pipes 35fi and 35ri (i=1, r), and braking force generating units 36fi and 36ri (i=1, r). A brake fluid pressure pipe 35f1 of the left front wheel Wfl and a brake fluid pressure pipe 35fr of the right front wheel Wfr are represented by 35fi. A brake fluid pressure pipe 35r1 of the left rear wheel Wrl and a brake fluid pressure pipe 35rr of the right rear wheel

Wrr are represented by 35ri. A braking force generating unit 36fl of the left front wheel Wfl and a braking force generating unit 36fr of the right front wheel Wfr are represented by 36fi. A braking force generating unit 36rl of the left rear wheel Wrl and a braking force generating unit 36rr of the right rear wheel

Wrr are represented by 36ri.

The brake pedal 31 is a braking operator operated by the driver when braking operation is performed. The brake booster 32 boosts an operation pressure (pedal force) associated with the braking operation of the driver input to the brake pedal 31 at a predetermined boost ratio. The master cylinder 33 converts the pedal pressure boosted by the brake booster 32 to a brake fluid pressure (hereinafter, referred to as “master cylinder pressure”) according to an operation amount of the brake pedal 31. The brake actuator 34 supplies the master cylinder pressure to each of the wheels Wfi and Wri directly or after adjusting the same for each wheel. The brake fluid pressure pipes 35fi and 35ri transmit the brake fluid pressure passing through the brake actuator 34 to each of the wheels Wfi and Wri. The braking force generating units 36fi and 36ri formed of a disk rotor, a caliper and the like, for example, generate the braking force on each of the wheels Wfi and Wri by supply of the brake fluid pressure of the brake fluid pressure pipes 35fi and 35ri, respectively.

The brake actuator 34 is provided with a normally-open pressure increasing valve and a normally-closed pressure decreasing valve for each of the wheels Wfi and Wri, for example. The brake actuator 34 is also provided with various control valves in addition to the pressure increasing valve and the pressure decreasing valve. The braking ECU 2 may generate the braking force of respective magnitude on each of the wheels Wfi and Wri by controlling the brake actuator 34 by predetermined open/close operation of each control valve.

The steering device 20 of the vehicle 10 is obtained by mechanically connecting the steering wheel 21 to the front wheel Wfi as described above. Therefore, vibration generated therebetween and vibration generated in association with an input from a road surface to the front wheel Wfi are transmitted to the steering wheel 21 through the steering shaft 22 and the like. The vibration of a steering system is transmitted to the driver through the steering wheel 21. Herein, the former vibration of the steering system generated in the device is uncomfortable for the driver and this may be said to be useless vibration for the driver. On the other hand, the latter vibration of the steering system associated with the input from the road surface transmits a condition of the road surface and a state of the front wheel Wfi with respect to the road surface to the driver and this may be said to be useful vibration for the driver. Therefore, the steering ECU 1 is provided with a vibration suppression control unit which suppresses the transmission of the useless vibration to the steering wheel 21 but allows the transmission of the useful vibration to the steering wheel 21. The vibration suppression control unit suppresses the useless vibration of the steering system, thereby transmitting the useful vibration associated with the input from the road surface to the steering wheel 21. That is to say, the steering control device of this embodiment tries to improve steering feeling of the driver by transmitting such useful vibration from the road surface to the steering wheel 21, thereby transmitting information of the vibration (so-called road information) to the driver.

The vibration suppression control may be performed by a method well known in this technical field. For example, the vibration suppression control is performed such that the vibration in a frequency band related to the road information (approximately 10 to 40 Hz) is left. However, the frequency band also includes the vibration at the time of braking (hereinafter, referred to as “braking time vibration”) (approximately 15 to 20 Hz). The braking time vibration is the vibration generated when the braking force generating unit 36fi generates the braking force on the front wheel Wfi, the vibration uncomfortable for the driver transmitted from the front wheel Wfi to the steering wheel 21 through the steering shaft 22 and the like. Therefore, the vibration suppression control unit of this embodiment is allowed to suppress the transmission of the braking time vibration associated with the braking operation of the front wheel Wfi to the steering wheel 21. Meanwhile, the frequency band is an example provided for convenience of description.

The braking time vibration is generated in a state in which there is abrasion of the disk rotor and a brake pad in the braking force generating unit 36fi and this may be indicated as a value obtained by multiplying variation in braking torque associated with the abrasion (variation from the braking torque at normal time without the abrasion) by an unsprung resonance frequency of the front wheel Wfi (approximately 15 to 20 Hz). Herein, the variation in the braking torque may be detected as variation in the brake fluid pressure of the front wheel Wfi.

Therefore, when the braking force is generated on the front wheel Wfi, the vibration suppression control unit is allowed to suppress the braking time vibration based on a value in a predetermined frequency band of the brake fluid pressure of the front wheel Wfi. The vibration suppression control unit determines whether there is the braking time vibration and a state thereof based on the value in the predetermined frequency band of the brake fluid pressure and, when there is the braking time vibration required to be suppressed, this tries to suppress the same. Meanwhile, the state of the braking time vibration indicates whether the braking time vibration is so large as to be transmitted to the driver.

The steering ECU 1 may directly receive a detection signal from a pressure sensor which detects the brake fluid pressure of the front wheel Wfi or may receive the detection signal from the braking ECU 2. This illustration is configured such that information may be communicated between the steering ECU 1 and the braking ECU 2 through a communication device (not illustrated). Therefore, the steering ECU 1 receives the detection signal of the brake fluid pressure of the front wheel Wfi through the braking ECU 2. Meanwhile, the communication device may directly connect the steering ECU 1 to the braking ECU 2 or may be realized by an in-vehicle network such as CAN and FlexRay.

If the brake fluid pressure of the front wheel Wfi may be grasped by a detection signal of a pressure sensor provided on the brake actuator 34, for example, the detection signal may be used. However, the variation in the brake fluid pressure of the front wheel Wfi associated with the variation in the braking torque is detected in a more attenuated manner as the pressure sensor is arranged farther from the braking force generating unit 36fi of the front wheel Wfi. Therefore, in this illustration, a pressure sensor 41fi (i=1, r) is arranged closer to the braking force generating unit 36fi as far as possible in the configuration. That is to say, the pressure sensor 41fi is allowed to detect the brake fluid pressure in a position closer to the braking force generating unit 36fi of the brake fluid pressure pipe 35fi of the front wheel Wfi.

The predetermined frequency band is the frequency band in which the braking time vibration is generated. In the above-described specific example, this is at approximately 15 to 20 Hz.

The vibration suppression control unit of this embodiment is allowed to execute the suppression control of the braking time vibration when the value in the predetermined frequency band of the brake fluid pressure of the front wheel Wfi is equal to or larger than a predetermined value.

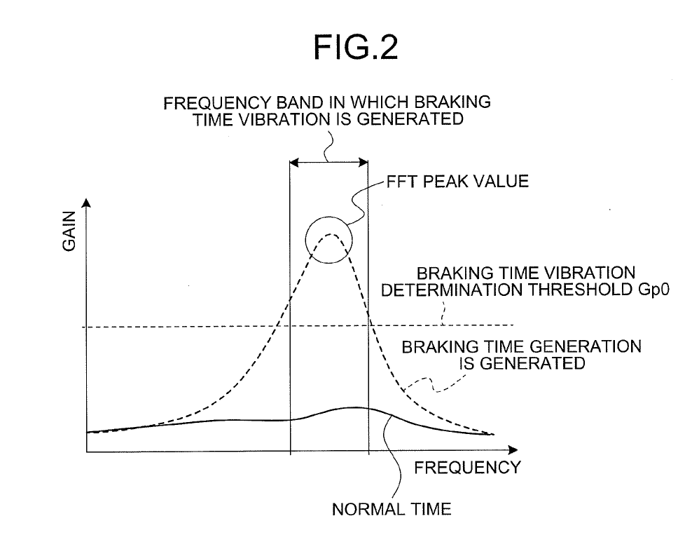

Specifically, the vibration suppression control unit is allowed to perform Fourier transform of the detection signal in the predetermined frequency band of the brake fluid pressure to obtain a gain of the detection signal. FIG. 2 illustrates the gain of the detection signal of the brake fluid pressure of the front wheel Wfi with respect to the frequency (hereinafter, also referred to as “brake fluid pressure gain”). A solid line indicates the brake fluid pressure gain of the front wheel Wfi at the normal time without the abrasion in the braking force generating unit 36fi and it is understood that the braking time vibration is not generated. On the other hand, a broken line indicates the brake fluid pressure gain of the front wheel Wfi when there is the abrasion in the braking force generating unit 36fi and it is understood that there is a peak gain (hereinafter, referred to as “FFT peak value”) in the predetermined frequency band. The vibration suppression control unit is allowed to execute the suppression control of the braking time vibration when the FFT peak value in the predetermined frequency band is equal to or larger than a predetermined value (hereinafter, referred to as “braking time vibration determination threshold)” Gp0.

Herein, not all the braking time vibration is necessarily transmitted to the driver but only large braking time vibration is transmitted to the driver through the steering wheel 21. Therefore, the brake fluid pressure gain of the front wheel Wfi in a case in which the braking time vibration transmitted to the driver is generated is herein made the braking time vibration determination threshold Gp0. Specifically, a minimum value of such brake fluid pressure gain (if there is a sensor detection error and an arithmetic error, a value obtained in view of them) is made the braking time vibration determination threshold Gp0. The vibration suppression control unit determines that the uncomfortable braking time vibration is generated when the FFT peak value is equal to or larger than the braking time vibration determination threshold Gp0.

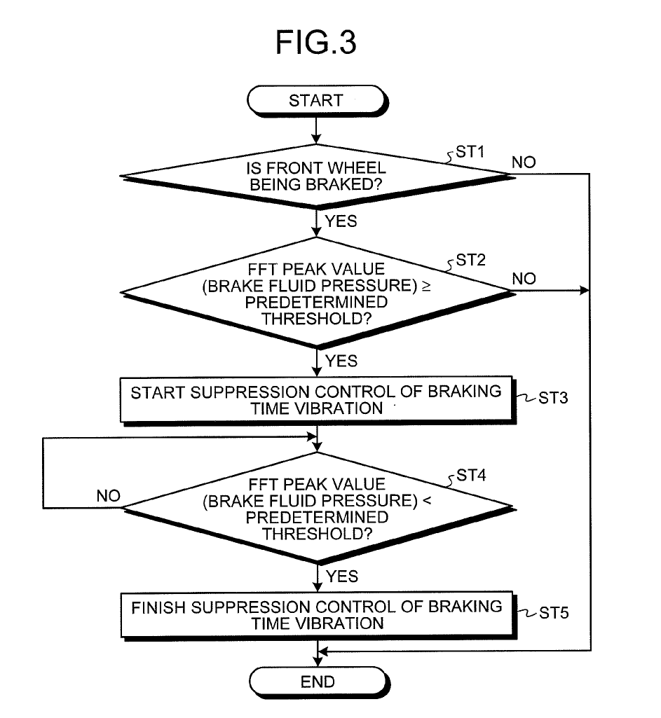

Arithmetic processing operation of the vibration suppression control unit is described with reference to a flowchart in FIG. 3. The arithmetic process may be performed before the above-described vibration useless for the driver (except the braking time vibration) is suppressed or performed in a state in which the useless vibration is suppressed and the vibration in the frequency band related to the road information is left. Meanwhile, in the former case, the left useless vibration is suppressed after the braking time vibration is suppressed or at the same time as the suppression control.

The vibration suppression control unit determines whether the braking force acts on the front wheel Wfi, that is to say, whether the front wheel Wfi is being braked (step ST1).

This may be determined based on whether the brake fluid pressure of the front wheel Wfi detected by the pressure sensor 41fi is equal to or higher than a predetermined pressure, for example. The predetermined pressure is set to be higher than a detection value of the pressure sensor 41fi at the time of non-braking. In this case, when the brake fluid pressure is equal to or higher than the predetermined pressure, it is determined that the braking force acts on the front wheel Wfi, and when the brake fluid pressure is lower than the predetermined pressure, it is determined that the braking force does not act on the front wheel Wfi. The determination at step ST1 may also be performed based on whether the master cylinder pressure detected by a master pressure sensor 42 is equal to or higher than a predetermined pressure. The predetermined pressure is set to be higher than a detection value of the master pressure sensor 42 at the time of non-braking. In this case, when the master cylinder pressure is equal to or higher than the predetermined pressure, it is determined that the braking force acts on the front wheel Wfi, and when the master cylinder pressure is lower than the predetermined pressure, it is determined that the braking force does not act on the front wheel Wfi. In this case, a detection signal of the master pressure sensor 42 may also be transmitted from the braking ECU 2 to the steering ECU 1. The determination at step ST1 may also be performed based on whether the operation amount of the brake pedal 31 (pedal depression amount or pedal force) is equal to or larger than a predetermined value. The predetermined value is provided for eliminating play of the pedal depression amount and the pedal force. In this case, when the operation amount is equal to or larger than the predetermined value, it is determined that the braking force acts on the front wheel Wfi, and when the operation amount is smaller than the predetermined value, it is determined that the braking force does not act on the front wheel Wfi. In this case, a detection signal of the pedal depression amount and the pedal force may also be transmitted from the braking ECU 2 to the steering ECU 1.

When the front wheel Wfi is not being braked, the braking time vibration is not generated, so that the vibration suppression control unit finishes the arithmetic process. Meanwhile, in this case, when the useless vibration of the steering system other than the braking time vibration is generated, it is desired to execute the suppression control of the vibration.

On the other hand, when the front wheel Wfi is being braked, the vibration suppression control unit performs the Fourier transform of the detection signal in the predetermined frequency band of the brake fluid pressure of the front wheel Wfi received from the braking ECU 2 and determines whether the FFT peak value of the detection signal of the brake fluid pressure in the predetermined frequency band is equal to or larger than the braking time vibration determination threshold (predetermined threshold) (step ST2). Herein, the FFT peak value may be obtained based on an average value and the like of the detection signal gain in the predetermined frequency band, for example.

When the FFT peak value in the predetermined frequency band is smaller than the braking time vibration determination threshold, the braking time vibration is not generated or the braking time vibration is less likely to be transmitted to the steering wheel 21 even when this is generated, so that the vibration suppression control unit finishes the arithmetic process. Meanwhile, in this case, when the useless vibration of the steering system other than the braking time vibration is generated, it is desired to execute the suppression control of the vibration.

On the other hand, when the FFT peak value in the predetermined frequency band is equal to or larger than the braking time vibration determination threshold, the braking time vibration might be transmitted to the steering wheel 21, so that the vibration suppression control unit starts the suppression control of the braking time vibration (step ST3).

The suppression control of the braking time vibration may be performed by a method well known in this technical field. The vibration suppression control unit suppresses the braking time vibration transmitted to the steering shaft 22 according to a control gain of the vibration suppression. For example, the vibration suppression control unit detects shaft torque of the steering shaft 22 from the torque sensor 25 and suppresses the braking time vibration based on a differential value of the shaft torque. The vibration suppression control unit may also suppress the braking time vibration by damping control by rotational angular speed control of the motor 24a. The vibration suppression control unit may perform the control based on the differential value of the shaft torque and the control by the rotational angular speed control of the motor 24a in order to improve an effect of suppressing the braking time vibration.

The vibration suppression control unit performs the Fourier transform of the detection signal in the predetermined frequency band of the brake fluid pressure of the front wheel Wfi newly received from the braking ECU 2 and determines whether the FFT peak value of the detection signal of the brake fluid pressure in the predetermined frequency band becomes smaller than the braking time vibration determination threshold Gp0 (step ST4). That is to say, the FFT peak value in the predetermined frequency band after the suppression control of the braking time vibration is started is herein compared with the braking time vibration determination threshold Gp0.

When the FFT peak value in the predetermined frequency band after the suppression control of the braking time vibration is started is still equal to or larger than the braking time vibration determination threshold Gp0, the vibration suppression control unit repeats the arithmetic process at step ST4 with the suppression control of the braking time vibration continued. When the FFT peak value in the predetermined frequency band after the suppression control of the braking time vibration is started becomes smaller than the braking time vibration determination threshold Gp0, the vibration suppression control unit finishes the suppression control of the braking time vibration (step ST5).

In this manner, the steering control device of this embodiment may extract the braking time vibration to be suppressed with high accuracy based on the value in the predetermined frequency band of the brake fluid pressure of the front wheel Wfi. Therefore, when the braking time vibration is generated and the braking time vibration is so large as to be transmitted to the driver, the steering control device may suppress the braking time vibration with high accuracy such that this is not transmitted to the driver. Therefore, the steering control device may correctly transmit the road information to the driver through the steering wheel 21 when the braking time vibration is not generated or when the braking time vibration is not to be suppressed.

### First Variation

A case in which a FFT peak value in a predetermined frequency band is equal to or larger than a braking time vibration determination threshold Gp0 is a state in which braking time vibration of magnitude required to be suppressed is generated as described above and this may be determined to be a state in which abrasion is generated in a braking force generating unit 36fi. Therefore, a vibration suppression control unit of this variation is allowed to count the number of times the FFT peak value in the predetermined frequency band becomes the braking time vibration determination threshold Gp0 or larger and determine that the braking force generating unit 36fi is in a state of easily generating the braking time vibration when the number of times becomes a predetermined number of times or larger. For example, when the FFT peak value in the predetermined frequency band becomes the braking time vibration determination threshold Gp0 or larger, the vibration suppression control unit is allowed to store this in a storage device and the like of a steering ECU 1, for example, and determine that the braking force generating unit 36fi is in the state of easily generating the braking time vibration when a history of the cases reaches a predetermined number of times or larger. For example, a state in which the history reaches the predetermined number of times or larger is intended to mean that the FFT peak value in the predetermined frequency band becomes the braking time vibration determination threshold Gp0 or larger in several times out of the number of times of braking operation of a driver. The predetermined number of times is provided for eliminating erroneous determination by a sensor detection error and the like and may be set in this point of view.

The vibration suppression control unit of this variation is allowed to make the above-described braking time vibration determination threshold Gp0 small when determining that the braking force generating unit 36fi is in the state of easily generating the braking time vibration. Herein, if there is no abrasion in the braking force generating unit 36fi, when the braking time vibration determination threshold Gp0 is made small, accuracy of determining whether the braking time vibration is to be suppressed becomes low and possibility of erroneously determining that the braking time vibration is to be suppressed becomes high. However, in a steering control device, it may be determined that the braking force generating unit 36fi is in the state of easily generating the braking time vibration from a past history, so that, if it is determined so, the possibility of erroneously determining that the braking time vibration is to be suppressed is low even when the braking time vibration determination threshold Gp0 is made small. Therefore, the steering control device may execute suppression control of the braking time vibration at early timing without deteriorating the accuracy of determining whether the braking time vibration is to be suppressed when determining that the braking force generating unit 36fi is in the state of easily generating the braking time vibration, so that it is possible to improve a transmission suppression effect of the braking time vibration as compared to the case of the embodiment in which the past history is not referred to.

### Second Variation

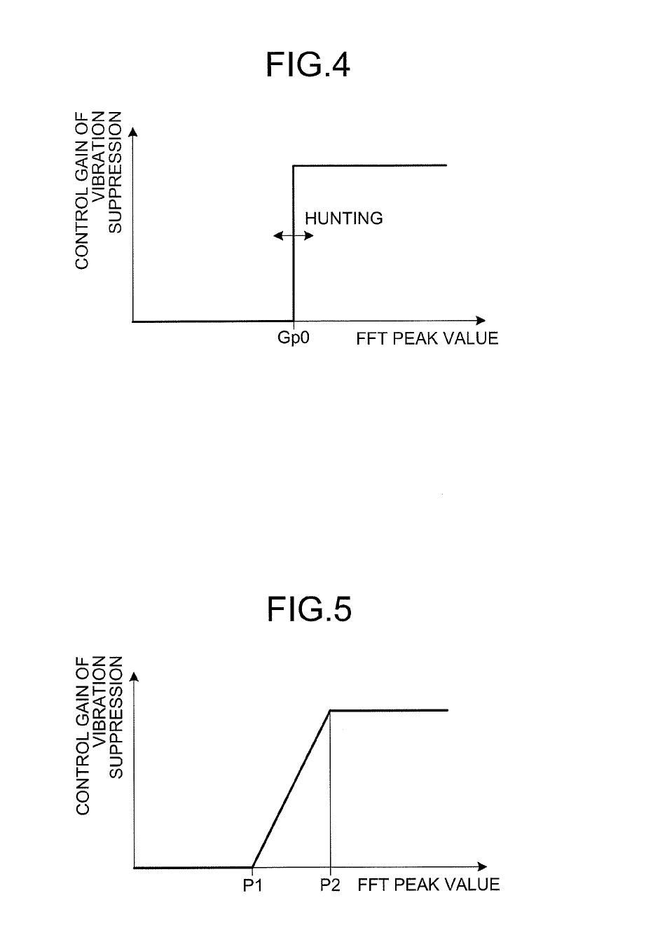

The steering control device of the above-described embodiment and first variation determines whether the suppression control of the braking time vibration is required based on one braking time vibration determination threshold Gp0, so that hunting might occur between on and off of the suppression control of the braking time vibration when the value in the predetermined frequency band of the brake fluid pressure (FFT peak value in the predetermined frequency band of the detection signal of the brake fluid pressure) is close to the braking time vibration determination threshold Gp0 (FIG. 4). Therefore, a steering control device of this variation changes a control gain of vibration suppression according to a value in a predetermined frequency band of a brake fluid pressure (FFT peak value in the predetermined frequency band of a detection signal of the brake fluid pressure) and performs suppression control of braking time vibration with the control gain of the vibration suppression according to this value, thereby preventing occurrence of hunting.

The control gain of the vibration suppression is set in advance. For example, the control gain of the vibration suppression is set such that, when the braking time vibration is generated, transmission of the braking time vibration to a steering wheel 21 may be suppressed. FIG. 5 is a map illustrating an example thereof.

In this map, when the FFT peak value in the predetermined frequency band is equal to or smaller than P1, the control gain of the vibration suppression is set to 0. The FFT peak value P1 is a maximum value of the FFT peak value in a predetermined frequency band in which the braking time vibration is not generated or the FFT peak value in a predetermined frequency band in which the braking time vibration is less likely to be transmitted to the steering wheel 21 even when this is generated (if there is a sensor detection error and an arithmetic error, a value obtained in view of them), for example. Therefore, when the FFT peak value in the predetermined frequency band is equal to or smaller than P1, the suppression control of the braking time vibration is not executed.

In this map, when the FFT peak value in the predetermined frequency band is larger than P1 and smaller than P2, it is set such that the control gain of the vibration suppression gradually becomes larger (with a constant proportional coefficient). The FFT peak value P2 is a minimum value of the FFT peak value in a predetermined frequency band when maximum braking time vibration is generated (if there is a sensor detection error and an arithmetic error, a value obtained in view of them), for example. In this map, when the FFT peak value in the predetermined frequency band is equal to or larger than P2, the control gain of the vibration suppression is set to a constant value.

For example, when a front wheel Wfi is being braked, the vibration suppression control unit of this variation calculates the control gain of the vibration suppression according to the FFT peak value in the predetermined frequency band and executes the suppression control of the braking time vibration based on the control gain. At that time, if the above-described map in FIG. 5 is used, when the FFT peak value is equal to or smaller than P1, the control gain of the vibration suppression reaches 0 and the suppression control of the braking time vibration is not executed. On the other hand, when the FFT peak value is larger than P1, the suppression control of the braking time vibration is executed with the control gain of the vibration suppression according to the FFT peak value. Therefore, the steering control device of this variation may execute the suppression control of the braking time vibration avoiding the hunting, so that stability of the suppression control is improved.

### Third Variation

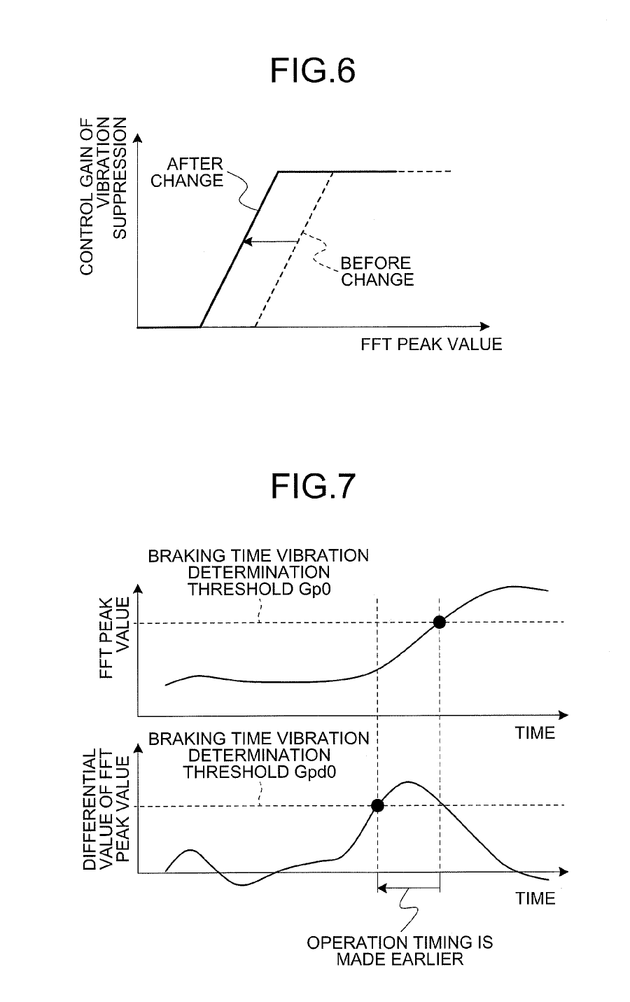

This variation is obtained by applying the contents of the above-described first variation to the steering control device of the second variation. A vibration suppression control unit of this variation is allowed to count the number of times a value in a predetermined frequency band of a brake fluid pressure (FFT peak value in the predetermined frequency band of a detection signal of the brake fluid pressure) becomes a braking time vibration determination threshold Gp0 or larger to determine that a braking force generating unit 36fi is in a state of easily generating braking time vibration when the number of times becomes a predetermined number of times or larger as in the first variation. The vibration suppression control unit is allowed to change a control gain of vibration suppression with respect to the value in the predetermined frequency band of the brake fluid pressure in the second variation (FFT peak value in the predetermined frequency band of the detection signal of the brake fluid pressure) when determining that the braking force generating unit 36fi is in the state of easily generating the braking time vibration. For example, FIG. 6 is obtained by changing the control gain of the vibration suppression in a map in FIG. 5. A solid line in FIG. 6 indicates the control gain of the vibration suppression after the change. A broken line indicates the control gain of the vibration suppression before the change.

Herein, when there is no abrasion in the braking force generating unit 36fi, if the control gain of the vibration suppression with respect to the FFT peak value is changed, accuracy of determining whether the braking time vibration is to be suppressed becomes low and possibility of erroneously determining that the braking time vibration is to be suppressed becomes high. However, in a steering control device, it may be determined that the braking force generating unit 36fi is in the state of easily generating the braking time vibration from a past history, so that, if it is determined so, the possibility of erroneously determining that the braking time vibration is to be suppressed is low even when the control gain of the vibration suppression with respect to the FFT peak value is changed. Therefore, the steering control device may execute suppression control of the braking time vibration at early timing without deteriorating the accuracy of determining whether the braking time vibration is to be suppressed when determining that the braking force generating unit 36fi is in the state of easily generating the braking time vibration, so that it is possible to improve a transmission suppression effect of the braking time vibration as compared to the case of the second variation in which the past history is not referred to.

### Fourth Variation

The steering control device of the above-described embodiment determines whether the braking time vibration is generated by using the value in the predetermined frequency band of the brake fluid pressure (FFT peak value in the predetermined frequency band of the detection signal of the brake fluid pressure), so that the suppression control of the braking time vibration acts after the vibration in the brake fluid pressure appears in the value obtained by performing the Fourier transform to a certain degree. Therefore, in the steering control device, the braking time vibration might be transmitted to the steering wheel 21 before the suppression control of the braking time vibration acts or by wasted time and the like. As described above, the braking time vibration might be erroneously determined by simply making the braking time vibration determination threshold Gp0 small. Therefore, a steering control device of this variation calculates a differential value of a value in a predetermined frequency band of a brake fluid pressure (FFT peak value in the predetermined frequency band of a detection signal of the brake fluid pressure) and executes suppression control of braking time vibration based on the differential value.

For example, a vibration suppression control unit of this variation is allowed to compare the differential value of the FFT peak value in the predetermined frequency band with a braking time vibration determination threshold Gpd0 and execute the suppression control of the braking time vibration when the differential value of the FFT peak value is equal to or larger than the braking time vibration determination threshold Gpd0. The braking time vibration determination threshold Gpd0 is set to a minimum value of a differential value of a brake fluid pressure gain of a front wheel Wfi when the braking time vibration transmitted to a driver is generated (when there is a sensor detection error and an arithmetic error, a value obtained in view of them), for example.

An upper part of FIG. 7 is illustrated for determining whether the braking time vibration is generated by comparing the FFT peak value in the predetermined frequency band with the braking time vibration determination threshold Gp0 as in the embodiment. A lower part of FIG. 7 is illustrated for determining whether the braking time vibration is generated by comparing the differential value of the FFT peak value in the predetermined frequency band with the braking time vibration determination threshold Gpd0. In this manner, the steering control device of this variation may determine the generation of the braking time vibration earlier by using the differential value of the FFT peak value as compared to the determination by using the FFT peak value. Therefore, the steering control device may make operation timing of the suppression control of the braking time vibration earlier as compared to that of the embodiment and may suppress transmission of the braking time vibration to a steering wheel 21 with higher accuracy.

Herein, the contents of this variation may also be applied to the steering control device of the above-described first variation. That is to say, the vibration suppression control unit of this variation is allowed to count the number of times the differential value of the value in the predetermined frequency band of the brake fluid pressure (FFT peak value in the predetermined frequency band of the detection signal of the brake fluid pressure) becomes the braking time vibration determination threshold Gpd0 or larger and determine that a braking force generating unit 36fi is in a state of easily generating the braking time vibration when the number of times becomes a predetermined number of times or larger. The vibration suppression control unit is allowed to make the braking time vibration determination threshold Gpd0 small as in the first variation when determining that the braking force generating unit 36fi is in the state of easily generating the braking time vibration. According to this, the steering control device may improve a transmission suppression effect of the braking time vibration as compared to the case of the above-described illustration in this variation in which a past history is not referred to.

### Fifth Variation

This variation is obtained by applying the contents of the above-described fourth variation to the steering control device of the second variation. That is to say, a vibration suppression control unit of this variation is allowed to change a control gain of vibration suppression according to a differential value of a value in a predetermined frequency band of a brake fluid pressure (FFT peak value in the predetermined frequency band of a detection signal of the brake fluid pressure) and execute suppression control of braking time vibration with the control gain of the vibration suppression according to this differential value. The control gain of the vibration suppression may suppress, when the braking time vibration is generated, transmission of the braking time vibration to a steering wheel 21 as in the second variation, for example, and this is set in advance. According to the steering control device of this variation, the suppression control of the braking time vibration avoiding hunting may be executed, so that stability of the suppression control is improved as compared to the steering control device of the fourth variation.

Herein, the contents of this variation may also be applied to the steering control device of the above-described third variation. That is to say, the vibration suppression control unit of this variation is allowed to count the number of times the differential value of the value in the predetermined frequency band of the brake fluid pressure (FFT peak value in the predetermined frequency band of the detection signal of the brake fluid pressure) becomes the braking time vibration determination threshold Gpd0 or larger and determine that a braking force generating unit 36fi is in a state of easily generating the braking time vibration when the number of times becomes a predetermined number of times or larger. The vibration suppression control unit is allowed to change the control gain of the vibration suppression with respect to the differential value of the value in the predetermined frequency band of the brake fluid pressure (FFT peak value in the predetermined frequency band of the detection signal of the brake fluid pressure) as in the third variation when determining that the braking force generating unit 36fi is in the state of easily generating the braking time vibration. According to this, the steering control device may improve a transmission suppression effect of the braking time vibration as compared to the case of the above-described illustration in this variation in which a past history is not referred to.

### Sixth Variation

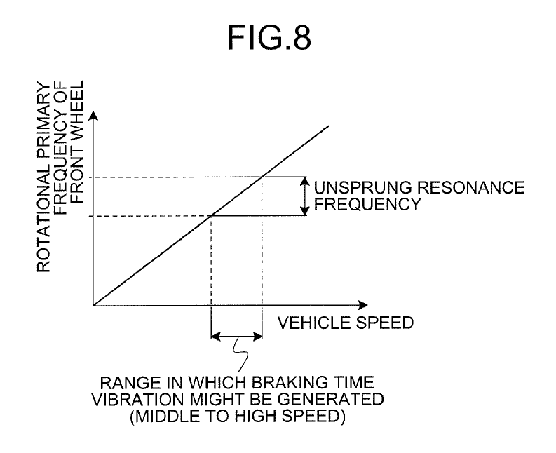

The above-described braking time vibration is likely to be generated mainly during travel in a middle to high vehicle speed range with moderate braking. During middle to high speed travel, the braking time vibration is estimated to be generated once per rotation of a front wheel Wfi as one cycle. FIG. 8 illustrates rotational primary frequency of the front wheel Wfi with respect to the vehicle speed. The rotational primary frequency of the front wheel Wfi during the middle to high speed travel substantially conforms to an unsprung resonance frequency of the front wheel Wfi. Therefore, a steering control device of this variation is such that determination of whether the braking time vibration is generated by determination of a travel condition (determination of whether the travel in the middle to high vehicle speed range is performed with the moderate braking) is also performed by the steering control device of the above-described embodiment and first to fifth variations.

Vehicle speed information by a vehicle speed sensor 43, wheel speed sensors 44fi and 44ri (i=1, r) and the like is used, for example, for determining whether the travel in the middle to high vehicle speed range is performed. The vehicle speed sensor 43 detects a rotational angle of an output shaft of a transmission, for example. The wheel speed sensors 44fi and 44ri detect rotational angles of axles of the wheels Wfi and Wri, respectively, for example. A wheel speed sensor 44f1 of a left front wheel Wfl and a wheel speed sensor 44fr of a right front wheel Wfr are represented by 44fi. A wheel speed sensor 44r1 of a left rear wheel Wrl and a wheel speed sensor 44rr of a right rear wheel Wrr are represented by 44ri. In contrast, vehicle deceleration information by a front-rear acceleration sensor 45, an output signal of a stop lamp switch 46 (brake ON signal) and the like are used, for example, for determining whether the travel is performed with the moderate braking.

The steering control device finally determines that the braking time vibration is generated when the steering control device of the above-described embodiment and first to fifth variations determines that the braking time vibration is generated and determines that the travel in the middle to high vehicle speed range is performed with the moderate braking and executes suppression control of the braking time vibration. On the other hand, the steering control device does not execute the suppression control of the braking time vibration when the steering control device of the above-described embodiment and first to fifth variations determines that the braking time vibration is not generated or determines that the travel is not performed in the middle to high vehicle speed range with the moderate braking. Therefore, the steering control device of this variation may improve accuracy of determining whether the braking time vibration is generated as compared to that of the embodiment and first to fifth variations, so that this may suppress transmission of the braking time vibration to a steering wheel 21 with higher accuracy.

### Reference Signs List

1 STEERING ECU

2 BRAKING ECU

10 VEHICLE

20 STEERING DEVICE

21 STEERING WHEEL

22 STEERING SHAFT

23 TURNING FORCE TRANSMITTING UNIT

24 STEERING ASSISTING UNIT

30 BRAKING DEVICE

31 BRAKE PEDAL

34 BRAKE ACTUATOR

41fi PRESSURE SENSOR

42 MASTER PRESSURE SENSOR

43 VEHICLE SPEED SENSOR

44fi, 44ri WHEEL SPEED SENSOR

45 FRONT-REAR ACCELERATION SENSOR

46 STOP LAMP SWITCH

Wfi FRONT WHEEL (TURNING WHEEL)

1. A steering control device comprising:
a vibration suppression control unit configured to suppress transmission of vibration of a steering system including a steering wheel and a turning wheel, which are mechanically connected to each other, to the steering wheel,
wherein the vibration suppression control unit is configured to execute, at a time a braking force is generated on the turning wheel, suppression control of braking time vibration associated with braking operation of the turning wheel based on a value in a predetermined frequency band of a brake fluid pressure of the turning wheel.

2. The steering control device according to claim 1, wherein the vibration suppression control unit is configured to execute the suppression control of the braking time vibration at a time the value in the predetermined frequency band of the brake fluid pressure is not smaller than a predetermined value.

3. The steering control device according to claim 2, wherein the vibration suppression control unit is configured to count number of times the value in the predetermined frequency band of the brake fluid pressure becomes the predetermined value or larger and to decrease the predetermined value at a time the number of times becomes a predetermined number of times or larger.

4. The steering control device according to claim 1, wherein the vibration suppression control unit is configured to change a control gain for suppressing the braking time vibration based on the value in the predetermined frequency band of the brake fluid pressure.

5. The steering control device according to claim 4, wherein the vibration suppression control unit is configured to count number of times the value in the predetermined frequency band of the brake fluid pressure becomes a predetermined value or larger and to change the control gain with respect to the value in the predetermined frequency band at a time the number of times becomes a predetermined number of times or larger.

6. The steering control device according to claim 1, wherein the vibration suppression control unit is configured to execute the suppression control of the braking time vibration based on a differential value of the value in the predetermined frequency band of the brake fluid pressure.

7. The steering control device according to claim 6, wherein the vibration suppression control unit is configured to execute the suppression control of the braking time vibration at a time the differential value of the value in the predetermined frequency band of the brake fluid pressure is equal to or larger than a predetermined value.

8. The steering control device according to claim 7, wherein the vibration suppression control unit is configured to count number of times the differential value of the value in the predetermined frequency band of the brake fluid pressure becomes the predetermined value or larger and to make the predetermined value small at a time the number of times becomes a predetermined number of times or larger.

9. The steering control device according to claim 6, wherein the vibration suppression control unit is configured to change a control gain for suppressing the braking time vibration based on the differential value of the value in the predetermined frequency band of the brake fluid pressure.

10. The steering control device according to claim 9, wherein the vibration suppression control unit is configured to count number of times the differential value of the value in the predetermined frequency band of the brake fluid pressure becomes a predetermined value or larger and to change the control gain with respect to the differential value of the value in the predetermined frequency band at a time the number of times becomes a predetermined number of times or larger.

11. The steering control device according to claim 1, wherein the value in the predetermined frequency band of the brake fluid pressure is a value obtained by performing Fourier transform of a detection signal of the brake fluid pressure in the predetermined frequency band.

12. The steering control device according to claim 2, wherein the value in the predetermined frequency band of the brake fluid pressure is a value obtained by performing Fourier transform of a detection signal of the brake fluid pressure in the predetermined frequency band.

13. The steering control device according to claim 3, wherein the value in the predetermined frequency band of the brake fluid pressure is a value obtained by performing Fourier transform of a detection signal of the brake fluid pressure in the predetermined frequency band.

14. The steering control device according to claim 4, wherein the value in the predetermined frequency band of the brake fluid pressure is a value obtained by performing Fourier transform of a detection signal of the brake fluid pressure in the predetermined frequency band.

15. The steering control device according to claim 5, wherein the value in the predetermined frequency band of the brake fluid pressure is a value obtained by performing Fourier transform of a detection signal of the brake fluid pressure in the predetermined frequency band.

16. The steering control device according to claim 6, wherein the value in the predetermined frequency band of the brake fluid pressure is a value obtained by performing Fourier transform of a detection signal of the brake fluid pressure in the predetermined frequency band.

17. The steering control device according to claim 7, wherein the value in the predetermined frequency band of the brake fluid pressure is a value obtained by performing Fourier transform of a detection signal of the brake fluid pressure in the predetermined frequency band.

18. The steering control device according to claim 8, wherein the value in the predetermined frequency band of the brake fluid pressure is a value obtained by performing Fourier transform of a detection signal of the brake fluid pressure in the predetermined frequency band.

19. The steering control device according to claim 9, wherein the value in the predetermined frequency band of the brake fluid pressure is a value obtained by performing Fourier transform of a detection signal of the brake fluid pressure in the predetermined frequency band.

20. The steering control device according to claim 10, wherein the value in the predetermined frequency band of the brake fluid pressure is a value obtained by performing Fourier transform of a detection signal of the brake fluid pressure in the predetermined frequency band.
